(19) United States
(12) Patent Application Publication
(10) Pub. No.: US 2008/0079227 A1
(43) Pub. Date: Apr. 3, 2008

(54) Tool cart and dolly apparatus

(76) Inventor: Vincent J Angellotto, Northern Cambria, PA (US)

Correspondence Address: MEYER UNKOVIC & SCOTT LLP, 1300 OLIVER BUILDING, PITTSBURGH, PA, 15222, US

(21) Appl. No.: 11/526,305

(22) Filed: Sep. 25, 2006

(51) Int. Cl. B62B 1/00

(52) U.S. Cl. 280/47.26

(57) ABSTRACT

A tool cart and dolly combination comprising of a storage box capable of storing a variety of interchangeable tools. A pair of wheels mounted to the lower back end of the tool cart. A foot is mounted to the front end of the base. Two female couplers are attached to and extend outwardly from the back end of the storage box. The elongated tool handles have a first end and a second end. The second end has a male coupler capable of removably attaching to the cart female coupler. Also provided herein are a variety of interchangeable tool heads with a tool-head female coupler attached thereto. A variety of short and long handles, all consisting of a first end and a second end, having a male coupler at the second end that is capable of releasably attaching to the tool-head female coupler.

### FIELD OF THE INVENTION

This invention relates generally to a tool cart and more particularly relates to a tool cart with interchangeable tools that provides the user with a dolly-like apparatus that can be manually propelled. The tool cart is used for hauling and storing interchangeable tools and other items used in and around the lawn and garden, such as fertilizer, mulch, dirt, flowers and seeds.

### BACKGROUND OF THE INVENTION

A typical gardener or landscaper has a variety of tools such as shovels, rakes, hoes, brooms, axes, picks and the like. Typically he or she desires to use many of these tools to accomplish a myriad of tasks around the yard. Hauling these garden tools and other materials around the yard can be cumbersome for individuals that work outside, both in a personal and professional capacity. Often it takes multiple trips to transport the necessary materials to the location where the work is to be done.

Various garden carts have been devised for transporting and storing tools and other gardening materials. These garden carts, however, have not been of the variety that allows the transport of such tools and garden materials in a compact, transportable, simple and easy-to-use fashion. While, some references have attempted to solve this ongoing problem by various methods, none have fully eliminated the problem.

U.S. Pat. No. 6,808,185 to Brace, for example, teaches a tool caddy and dolly. The dolly is capable of storing only a limited number of tool heads. Two long handles add extra bulk to this dolly by attaching to the side of the dolly. One of the disadvantages of this invention is that it is only capable of storing five tool heads. Moreover, this invention is not capable of transporting garden and yard materials like dirt, fertilizer, flower pots, trays of plant material or the like.

A similar reference, U.S. Pat. No. 4,350,366 to Helms, discloses a lawn and garden cart capable of carrying lawn and garden tools. One of the disadvantages of this invention is that it is bulky and cumbersome to move around the yard. Additionally, the size of the device makes it difficult to store. Further, the device does not come with its own custom tool handles and tool heads that fit compactly into the cart as disclosed in the present invention.

Another related patent, U.S. Pat. No. 5,833,250 to Walter, discloses a garden cart that can be pushed or pulled around the yard. Like the previously discussed inventions, a disadvantage of the Walter device is that it is bulky and cumbersome to move around the yard. Similarly, the size of the device makes it difficult to store. Again, the device does not provide its own custom tool handles and heads that fit compactly into the cart.

The present invention overcomes the disadvantages of the related references as discussed below.

### SUMMARY OF THE INVENTION

An object of the present invention is to provide a tool cart that limits the number of long and short-handled tools that are required to be carried to the work site.

Another object of the present invention is to provide a tool cart that can easily transport other gardening materials such as dirt, mulch, fertilizer, lime, flower pots and trays of plant material.

Yet another object of the present invention is to provide a plurality of interchangeable tool heads and handles to decrease the cost and time involved in acquiring each tool individually.

Yet another object of the present invention is to store a variety of interchangeable tools, including the tool heads and the tool handles.

Yet another object of the present invention is to provide a tool cart that is free standing.

Yet another object of the present invention is to provide a tool cart that is compact and easily storable.

Specifically, what is provided in a preferred embodiment is a tool cart and dolly combination comprised of a storage box capable of storing a variety of interchangeable tools with an upper, lower, front and back end. A pair of wheels are rotateably mounted to the lower back end of the storage box or on an optional axle. At least one, cart female coupler is attached to and extends outwardly from the back end of the storage box. The invention further comprises two elongated tool handles having a first end and a second end. The second end has a male coupler capable of releasably inserting into the cart female coupler, attached to the back end of the storage box, with a push button means to form the handles of the dolly.

Also provided herein are a variety of interchangeable tool heads with a tool-head female coupler attached thereto. Further provided are a variety of short and long handles, all comprising a first end and second end, having a male coupler at the second end that is releasably attached to the tool-head female coupler of the tool heads via a push button device.

Also provided in another preferred embodiment is a tool cart comprising a storage box, having a lid attached thereto, two elongated handles removeably attached to the storage box, wherein the two elongated handles attach to a plurality of interchangeable tools through use of a push button device. The push button device further comprises two oppositely facing and outwardly biased tabs, at least one compression spring and at least two interlocking L-shaped members. Two wheels are mounted to the side walls of the storage box, and a U-shaped foot is attached to a bottom portion of the storage box. The two elongated handles connect to a back end of the storage box by means two cart female couplers, wherein the two cart female couplers are rigidly mounted to and extend outwardly from the back end of the storage box. The invention further comprises a net attached to the two elongated handles to aid in carrying materials. The interchangeable tools are selected from the group consisting of a flat shovel, a spade shovel, garden rake, leaf rake, hoe, broom, push broom, trench shovel, ax, sledge hammer, pick or other tools.

### BRIEF DESCRIPTION OF THE FIGURES

FIG. 1 displays a front view of the tool cart and dolly combination of the present invention.

FIG. 2 shows a side view of the tool cart and dolly combination of the present invention.

FIG. 3 shows a rear view of the tool cart and dolly combination of the present invention

FIG. 4 illustrates the plurality of tool handles available for the interchangeable tools of the present invention.

FIG. 5 shows an exploded side view of the push button device that is used to secure the plurality of interchangeable handles to the plurality of tool heads.

FIG. 6 displays a top view of the push button springing mechanism for the interchangeable tools of the present invention.

FIG. 7 shows the plurality of tool heads with the attached tool-head female coupler of the present invention.

FIG. 8 illustrates a top view of the tool-head female coupler of the present invention.

FIG. 9 displays a side view of the tool-head female coupler on a tool head of the present invention FIG. 10 illustrates a front view of an interchangeable tool head secured to an interchangeable handle of the present invention by means of the push button mechanism.

FIG. 11 illustrates a front view of the present invention carrying materials.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated apparatus and method, and such further applications of the principles of the invention illustrated herein, as would normally occur to persons skilled in the art to which the invention relates.

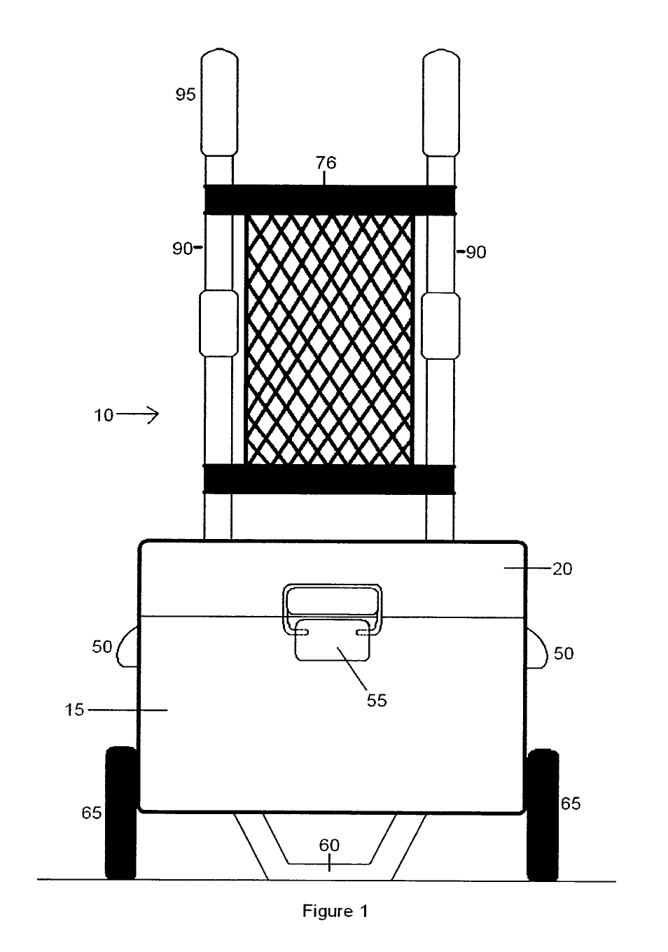

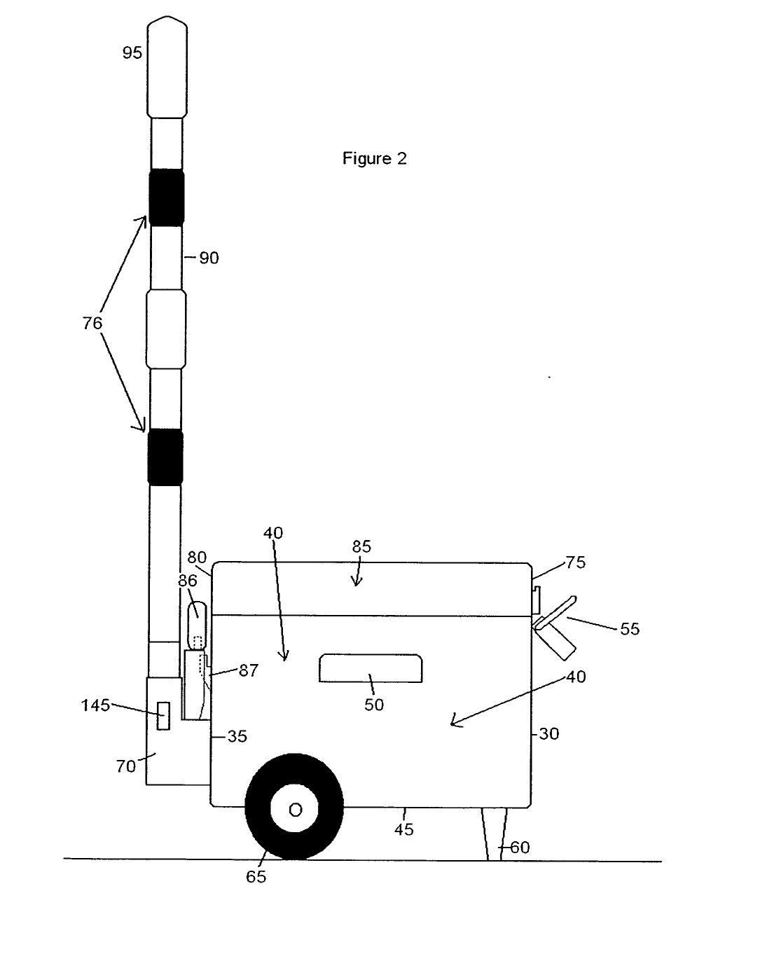

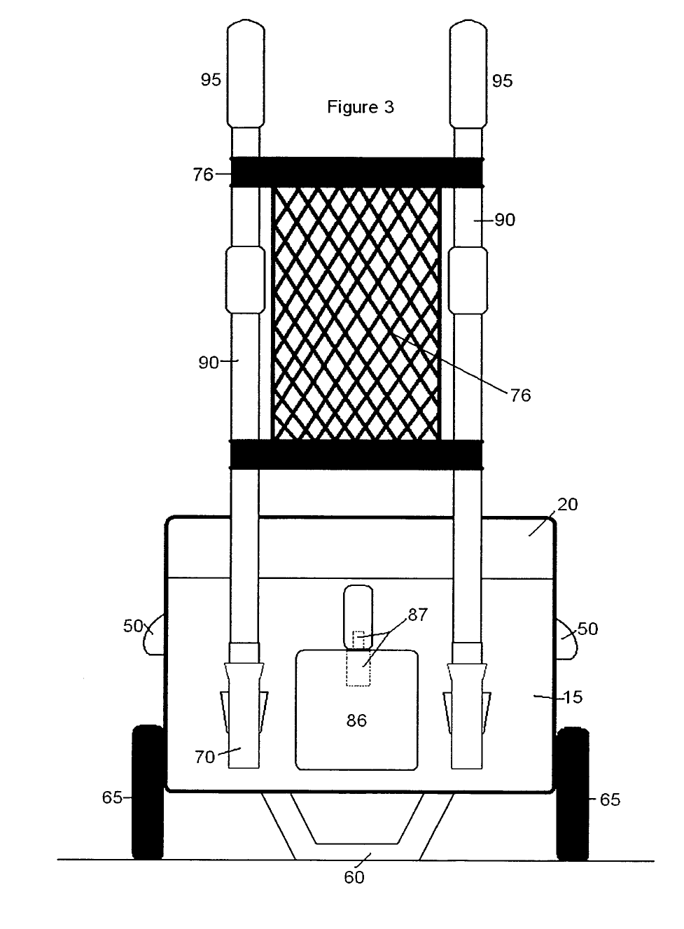

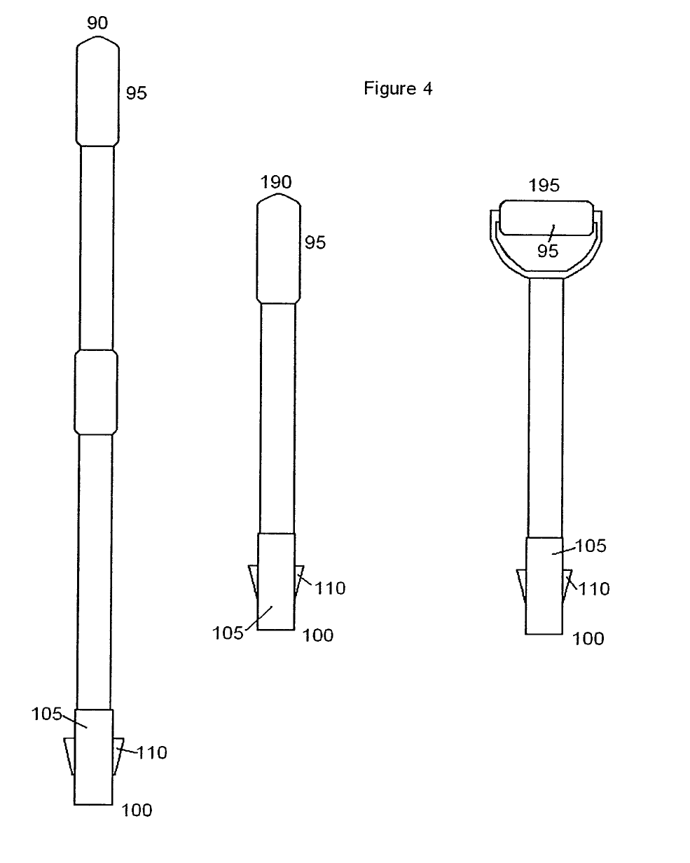

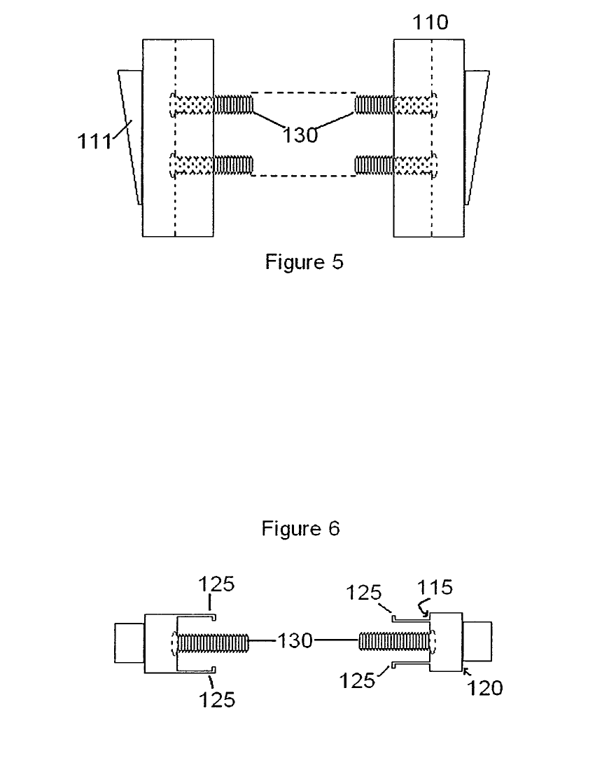

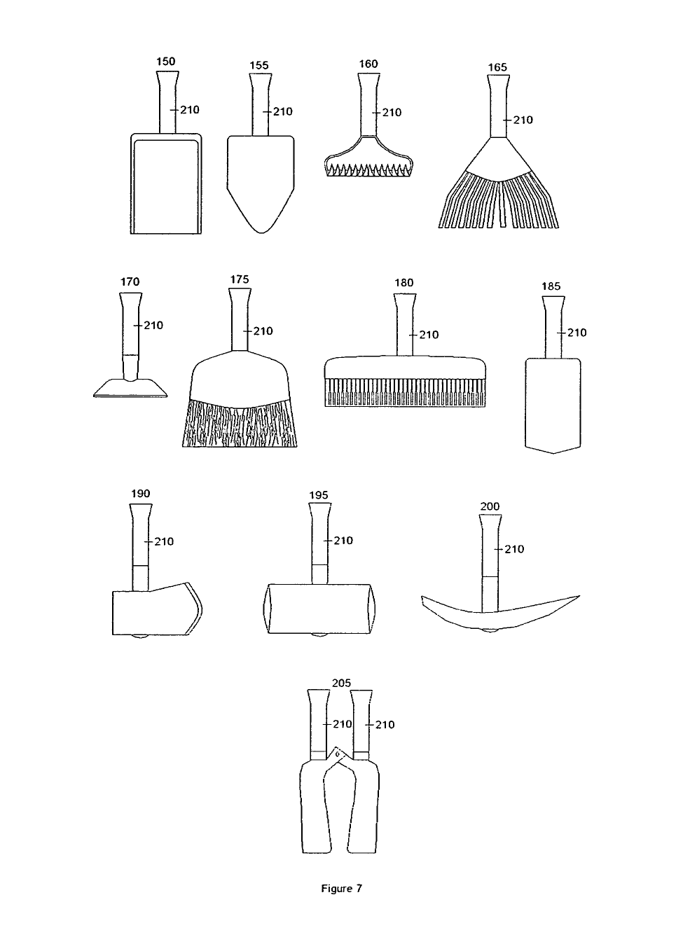

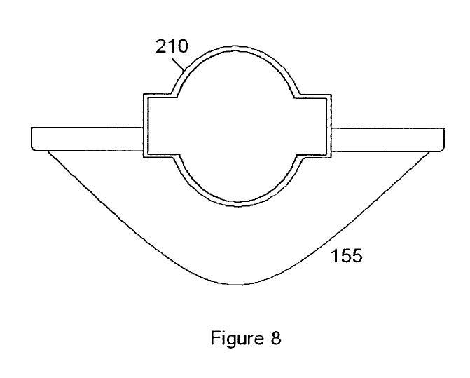

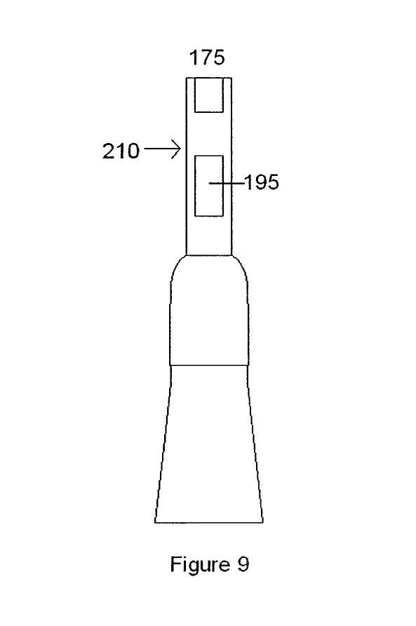

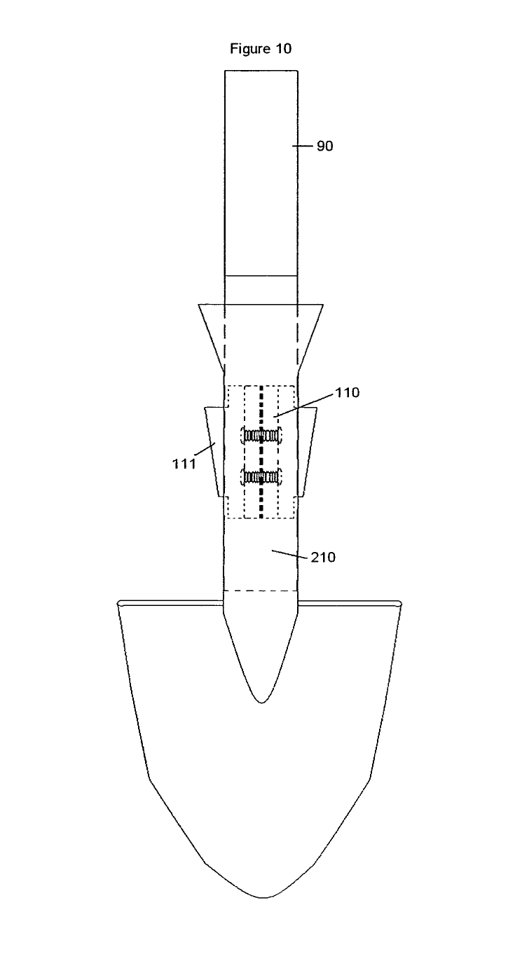

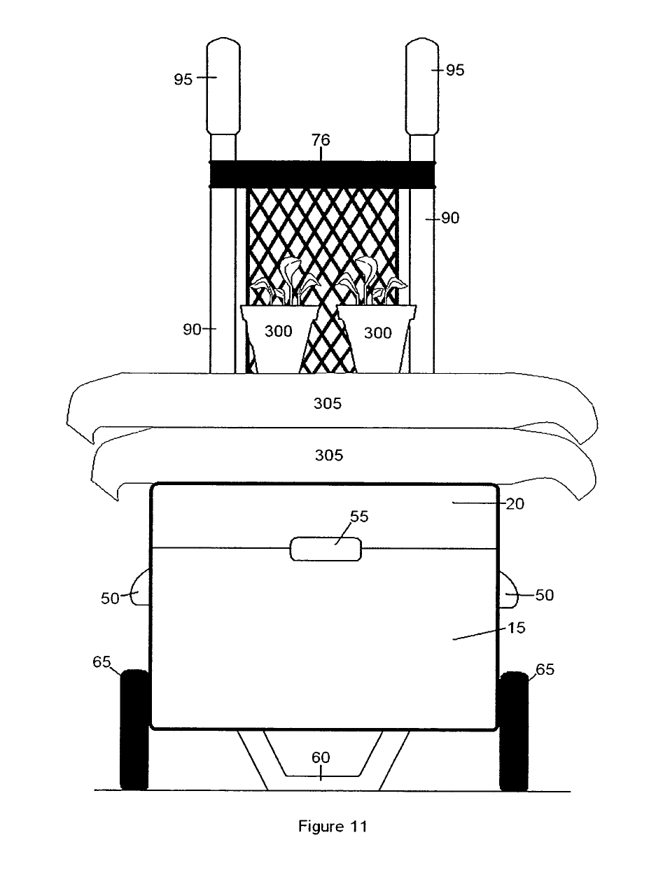

Referring now to FIGS. 1-11, the tool cart and dolly combination 10 has a storage box 15 with a lid 20 that is optionally pivotably mounted to the storage box 15. The lid 20 comprises of a front end 75, back end 80 and sides 85. A locking mechanism 55 releasably couples the lid 20 to the storage box 15.

The storage box 15 consists of a front wall 30, back wall 35, and side walls 40 each having a front and back face, and a base 45 having a front and back end. In the preferred embodiment, at least two handles 50 are mounted to and extend away from the sidewalls 40. Alternatively, in another embodiment, the handles 50 can be mounted to the side of the lid 85. In the preferred embodiment, a dustpan 86 releasably couples to a male connector 87 mounted to the back wall 35. Optionally, the male connector 87 may be mounted to the side walls 40 or front wall 30.

In a preferred embodiment, a pair of wheels 65 are mounted to the back lower portion of the side walls 40. Optionally, the wheels 65 may be attached to an axle that is mounted to the base 45 of the storage box 15. The wheels 65 are made of plastic, metal, rubber or any other similar material known to those skilled in the art.

In the preferred embodiment, a foot 60 is mounted to the front end of the base 45 and is generally oriented perpendicular to the horizontal plane of the base 45. The foot 60 is made of plastic, metal, rubber or any other similar material known to those skilled in the art. The foot 60 may be U-shaped, rectangular, square, circular or any other shape. In another embodiment, a plurality of feet 60 are provided instead of one foot.

The tool handles of the present invention included a pair of elongated tool handles 90, at least one short handle 190 and at least one D-handle 195. In another embodiment, the tool handles include any gardening or landscaping handle known to those skilled in the art. Each handle consists of a first end 95 and a second end 100. The second end 100 on each handle includes a male coupler 105 integrally disposed thereon. Each male coupler 105 is the same and includes a push button device 110 that is situated inside the handle and biased outwardly therefrom by means of at least one compression spring. The push button device 110 can be used on the long handle 90, the short handle 190, the d-handle 195 or any other gardening or landscaping handle known to those skilled in the art.

The push button device 110 consists of an inside 115 and outside 120. Oppositely disposed L-shaped interlocking members 125 are rigidly attached to the inside 115 of the push button device 110. The push button device 110 compresses and releases by means of at least one compression spring 130 that is attached to the inside 115 of the push button device 110. When a user pushes the outer tabs 111 of the push button device 110, the spring 130 compresses inward so that the tabs 111 of the push button device 110 release from or lock to the female coupler 70.

Also provided is at least one cart female coupler 70, capable of releaseably coupling to the male coupler 105 of the elongated tool handles 90 and is mounted to the back wall 35 of the storage box 15. Preferably, two cart female couplers 70 are included in the present invention. Specifically, each cart female coupler 70 consists of vertical openings 145 for receiving the tabs 111 of the push button device 110 in the male coupler 105.

Once the elongated tool handles 90 are attached to the female coupler 70, a net 76 can optionally be secured to the elongated handles with Velcro™, straps, brackets or other attachment means known to those skilled in the art.

In a preferred embodiment, the plurality of interchangeable tool heads include a flat shovel 150, a spade shovel 155, garden rake 160, leaf rake 165, hoe 170, broom 175, push broom 180, trench shovel 185, ax 190, sledge hammer 195, pick 200 and post hole digger 205. In other embodiments, the plurality of tool heads includes any gardening or landscaping tool head known to those skilled in the art. Each of the plurality of tool heads has a tool-head female coupler 210 attached thereto that is capable of releasably attaching to the male coupler 105 disposed on the plurality of tool handles. Specifically, the tool-head female coupler 210 consists of vertical openings 195 for receiving the tabs 111 of the push button mechanism 110 on the male coupler 105.

The invention can be used for hauling and storing a plurality of interchangeable tool heads. The invention can also be used to easily transport other gardening materials such as dirt, mulch, lime, fertilizer 305, flower pots 300, trays of plant material or the like.

I claim:

1. A tool cart comprising:
a storage box;
two elongated handles removeably attached to said storage box, wherein said two elongated handles also attach to a plurality of interchangeable tools through use of a push button device;
two wheels mounted to side walls of said storage box; and
a foot attached to a bottom portion of said storage box.

2. The tool cart of claim 1, wherein said two elongated handles are connected to a back end of said storage box by means of two cart female couplers; wherein said two cart female couplers are rigidly mounted to and extend outwardly from said back end of said storage box.

3. The tool cart of claim 1, further comprising a net attached to said two elongated handles to aid in carrying materials.

4. The tool cart of claim 1, wherein said foot is U-shaped.

5. The tool cart of claim 1, wherein said interchangeable tools are selected from the group consisting of a flat shovel, a spade shovel, garden rake, leaf rake, hoe, broom, push broom, trench shovel, ax, sledge hammer and a pick.

6. The tool cart of claim 1, wherein said push button device further comprises two oppositely facing and outwardly biased tabs, at least one compression spring and at least two interlocking L-shaped members.

7. A multi-purpose tool cart comprising:
a storage box;
two elongated handles removeably attached to said storage box, wherein said two elongated handles also attach to a plurality of interchangeable tools through use of a push button device;
two wheels mounted on an axle attached to a bottom side of said storage box; and
a U-shaped foot attached to a front bottom portion of said storage box.

8. The multi-purpose tool cart of claim 7, wherein said two elongated handles connect to a back of said storage box by means of two cart female couplers, wherein said two cart female couplers are rigidly mounted to and extend outwardly from a back of said storage box.

9. The multi-purpose tool cart of claim 7, further comprising a lid pivotably attached to said storage box.

10. The multi-purpose tool cart of claim 7, further comprising a net attached to said two elongated handles.

11. The multi-purpose tool cart of claim 7, wherein said interchangeable tools are selected from the group consisting of a flat shovel, a spade shovel, garden rake, leaf rake, hoe, broom, push broom, trench shovel, ax, sledge hammer and a pick 200.

12. The multi-purpose tool cart of claim 7, wherein said push button device further comprises two oppositely facing and outwardly biased tabs, at least one compression spring and at least two interlocking L-shaped members.

13. A multi-purpose tool cart comprising:
a storage box;
two elongated handles removeably attached to said storage box; wherein said two elongated handles also attach to a plurality of interchangeable tools through use of a push button device;
said push button device further comprises two oppositely facing and outwardly biased tabs, at least one compression spring and at least two interlocking L-shaped members;
two wheels attached to a side of said storage box; and
a U-shaped foot attached to a front portion of said storage box.

14. The multi-purpose tool cart of claim 13, wherein said two elongated handles connect to a back of said storage box by means of two cart female couplers, wherein said two cart female couplers are rigidly mounted to and extend outwardly from said back of said storage box.

15. The multi-purpose tool cart of claim 13, further comprising a lid attached to said storage box.

16. The multi-purpose tool cart of claim 13, further comprising a net attached to said two elongated handles.

17. The multi-purpose tool cart of claim 13, wherein said interchangeable tools are selected from the group consisting of a flat shovel, a spade shovel, garden rake, leaf rake, hoe, broom, push broom, trench shovel, ax, sledge hammer and a pick 200.

18. The multi-purpose tool cart of claim 15, wherein said lid is pivotably attached to said storage box.

19. The multi-purpose tool cart of claim 15, further comprising a locking mechanism which releasably couples said lid to said storage box.
